(19) United States
(12) Patent Application Publication
(10) Pub. No.: US 2008/0255993 A1
(43) Pub. Date: Oct. 16, 2008

(54) Mobile payment and accounting system with integrated user defined credit and security matrixes

(76) Inventor: Jacques Blinbaum, New York, NY (US)

Correspondence Address: JACQUES BLINBAUM, 114 EAST 78TH STREET, NEW YORK, NY, 10075, US

(21) Appl. No.: 12/082,875

(22) Filed: Apr. 15, 2008

Related U.S. Application Data
(60) Provisional application No. 60/923,538, filed on Apr. 16, 2007.

(51) Int. Cl. G06Q 40/00

(52) U.S. Cl. 705/44

(57) ABSTRACT

A platform that accommodates financial transactions and is accessible via mobile phone networks, Internet and traditional methods is linked to user defined credit and security matrixes. Credit risk tolerance factors consider the qualifications, characteristics, and profile of counterparties. Security risk tolerance factors consider the user's willingness to use a particular financial platform in an environment where abuse, fraud, theft, and other security factors are of concern. In both cases the user creates matrixes that describe risk tolerance and financial transactions must successfully pass through the filters designed by the user. The system can be used alone or linked to bank accounts, credit and debit accounts, etc. This provides a higher level of security and risk control in a mobile or Web-based environment. By giving customers way to control risk, use of new electronic methods of payment and other financial transactions can be accommodated in a more comfortable, secure, and efficient manner.

This application claims the benefit of pending provisional application 60/923,538 filing date Apr. 16, 2007 titled “Mobile payment and accounting system with integrated user defined credit and security matrixes employing cellular phone technologies and internet protocols”.

### BACKGROUND OF THE INVENTION

1. Field of Invention

This invention relates to a process whereby one is able to create credit risk and/or security risk models and integrate these into electronic payment platforms to create user defined payment/credit solutions that controls credit risk, controls security risks, handles electronic payments, and tracks debits and credits using a combination of internet protocols and cellular based functionalities.

2. Discussion of Prior Art

Payment for goods and services transacted via electronic commerce is currently predominantly reliant on credit or debit cards. Over the past few years alternative solutions have evolved that transfer payment information using cell phone based technologies. Today's cell phones have many functions that make data transfer routine including Text Messaging (also referred to as SMS), the use of cellular web browsers, and Java applications. Many companies are using these applications to transmit payment data to processors using cellular phone networks.

In addition, other solutions integrate a chip into the process which is able to interact with transceivers to store and/or transmit payment data. These are often referred to as NFC (near field communications) solutions.

All these systems work in a manner that replicates the traditional credit/debit card model of gathering payment information, transmitting the information to a processing center for analysis, and responding with an approval or rejection of the transaction.

These systems serve the needs of traditional merchants and customers and, in some cases, have been modified to accommodate transfers of funds between user accounts on a peer-to-peer basis. In all cases the processing and authorization model is singular and responds to a standard, service provider set of protocols which do not necessarily serve all users efficiently. There is no recognition of “relative risk” among the multitude of transactions and therefore the process is often clumsy, time consuming, and expensive.

Furthermore, existing solutions do not allow individual users to set up their individual risk tolerance criteria to create a matrix of transfer rules that govern a wide range of payment/credit situations and security situations. Everyone is forced to fit into a standard solution.

There is a real and urgent need for an electronic funds transfer solution that can be individually tailored to suit user determined criteria with respect to funds transfers.

### SUMMARY OF THE INVENTION

The present invention is a business process that enables persons and businesses to receive and pay funds over Internet based or mobile phone based networks subject to multiple security and credit business criteria that are determined by the users.

### Objects and Advantages

Our process provides a solution to many complex credit and security issues by offering users a business model that recognizes that transaction counterparties can be organized into groups or communities that impact on the degree of financial and/or transaction risk associated with particular payment transactions. By considering the differing risk groups, different business terms can be imposed to reflect the appropriate level of security features that need be imposed and whether credit should be granted or denied. This results in the creation of multiple risk matrixes that can be customized to reflect varying financial transaction scenarios including payments, loans, and shared expense situations. When considering the risk profile of a particular transaction the matrix can relax or increase the limits that are imposed on the transaction.

While some users will use the risk matrix to establish lending or credit criteria, others can use it to place limitations on outgoing payment options so as to add security to their use of mobile systems as a payment option.

This solution operates in either a mobile, internet, or card based environment and all functions are integrated into a single product. Accordingly, several of the objects and advantages of our invention are:
To provide users with the ability to make financial payments using either the Internet or their cellular phones subject to user defined business/security rules and limitations
To provide users with the ability to extend or receive credit using either the Internet or their cellular phones subject to user defined business/security rules and limitations
To provide users with the ability to record financial transaction and integrate these into a shared payment solution that allows for the tracking and payment of shared obligations
To provide users with a platform that allows for user to track payment data and related memorandum information in a manner that can be retrieved in the form of reports and billing information using cellular phones.
To provide users with a single mobile based platform that can collect and consolidate payment and billing information from a range of different sources and consolidate this information to form a single, mobile, integrated financial management system
To provide all these functions with the ability to link payments to establish banking solutions like credit and debit cards, bank accounts, and ATM machines.
To provide users with the ability to create private label credit offerings using mobile phone technology employing user assigned risk models
To provide private lenders with a way to lend funds, track loans, and receive repayments in a mobile environment
   To provide users with the ability to use functions before registering in the system and later register and associate transactions with their account.

### BRIEF DESCRIPTION OF THE DRAWINGS

Attached are flow charts showing the manner in which the process works.

FIG. 1 shows how the system will integrate the creation of user defined Credit Matrixes and Transaction Matrixes in the registration process. FIG. 1 is followed by a verbal description of the process and the considerations that are involved in creating the matrixes

FIG. 2 shows a flow chart describing the manner in which financial transactions are processed using the Security and Credit Matrixes. FIG. 2 is followed by a verbal description of the process.

### DESCRIPTION OF THE PREFERRED EMBODIMENTS

Our invention is a process whereby parties who desire to enter into financial transactions are able to create various matrixes which define sets of business rules which must be accommodated prior to the completion of a financial transaction. These matrixes can be constructed around a wide range of variables and are most specifically focused in the areas of transaction security and in the area and providing credits to counterparties.

Using our invention persons or entities that desire to receive payment from various payers are able to establish group risk models and assign each customer to a particular group. Alternatively, users are able to create a unique risk model for any individual customer. Thereafter, transactions are processed according to the terms of the particular assigned risk profile and either approved or rejected based on the particular risk model that applies. Applications of this model are in both the peer-to-peer environment and in the merchant environment.

Using our invention persons or entities are also able to establish security models that determine the specific security safeguards that will be imposed on a particular transaction prior to acceptance by the system. Although these security safeguards are primarily implemented by the party making the payment there will be circumstances whereby the party receiving the payment requires compliance with security controls.

Using our payment platform the user registers within the system by creating a virtual account which is similar to an online bank account. The user identifies him/herself and provides information places the user in one or more “groups” or “communities”. Examples of these are students at a particular school, members of a military unit, or workers within a company.

Users are able to transfer funds from traditional funding sources like bank accounts, credit cards, and debit cards into their virtual account using the Internet or via mobile phone applications. From this virtual account the user has a range of transaction options and setup options.

Setup options address issues of payment security where the user can customize the rules under which payments can be made using the mobile or Internet environment. Users are able to create a matrix of security based limits which would apply to any group or individual. Security limitations will not only respond to standard categories but users will be able to add their personal categories as appropriate. Standard security categories would include, but not be limited to, rules requiring use of a PIN (personal identifier number) to authorize transactions, maximum transaction amount, maximum number of transactions within a specified time period, transaction limits to a particular account, among others.

Transaction options address issues of granting credit to others. Rules governing the granting of credit are reflected in a separate matrix which considers the counterparty's group affiliation and individual criteria. Transaction limits are established and prospective transactions are screened accordingly. Factors include, but are not limited to, amount of credit provided to counterparty by the user, total amount of credit user will accept, total amount of debt counterparty has in place, counterparty's payment history, flexible interest rate schedules based on multiple variables, to name a few.

Users making payments as well as users receiving payments are able to integrate both security and transaction matrixes into their account structure.

When a transaction is initiated via a mobile phone or the Internet our payment platform identifies the parties, analyzes the transaction, examines the multiple security and transaction matrixes that govern the transaction, and determines if the proposed transaction meets all the criteria needed for approval. If it does, then the transaction is approved and the accounts are recorded as appropriate. If it does not, then the transaction is rejected. In all cases the parties are notified by a SMS message and/or an e-mail message. A complete record of all transactions, whether accepted or rejected, is maintained by the system.

### DESCRIPTION OF ADDITIONAL EMBODIMENTS

An alternative manner of accepting cash deposits would include a system whereby a customer could make a cash deposit into his account using physical cash receiving networks like storefronts, via ATMs (automatic teller machines), or by the purchase of a prepaid card. This card would provide encoded information to the purchaser that would be entered into the purchaser's account via the mobile phone or the Internet. Once the information is entered the account will be credited with the appropriate amount.

Another use for this process relates to the banking and financial services industries. Banks and institutions, using this system, would be able to offer customers various services by linking our platform to their own account platform. In this manner, our system can become an extension of their banking platform and many of their financial products can be extended to the mobile payment environment including the ability to accommodate mobile debit purchases, mobile credit purchases, mobile loyalty programs, mobile bill payment services, and mobile account access capability.

Another application of our system would be in the field of private label credit and payment solutions. Using our system stores, communities, and groups could create and administer credit solutions to attract customers and build customer relationships.

Another application of our system is in the area of prepaid services like prepaid phone cards. The current model provides for the production and distribution of scratch-off type cards with hidden codes used to identify a purchase and validate payment. Using our system the entire process could be streamlined, the production of physical cards could be eliminated, the problems of collection from authorized vendors would be eliminated, and the entire process would be transferred to a mobile phone/Internet based environment. It would only be necessary for the service provider and the authorized vendor of service to both have accounts on our system. The rest of the process could be accommodated using mobile services like SMS as in the following example for the prepaid phone card industry:
1. Telecom supplier opens virtual account
2. Authorized vendor opens virtual account
3. Customer comes to vendor to purchase credits for cash
4. Vendor accepts cash and requests specific credit from telecom vendor via SMS or Internet
5. Telecom responds with SMS authorization code to vendor or directly to customer's mobile phone
6. Vendor's account is debited appropriate amount
7. Telecom's account is credited appropriate amount
8. Detailed record of transaction is maintained by our system
9. Full suite of reports is made available to both telecom and vendor

Another application of our system is in the area of government programs when physical networks become unreliable as after a major natural disaster like a hurricane. Using our platform funds could be distributed to, and maintained by, recipients using mobile phone networks. All transaction between individuals, vendors, financial institutions, and agencies would be maintained in detail and a full range of reports would be available to all parties.

Another application of our system is in the area of money transfer between parties that lack traditional bank accounts. Our system would function as a prepaid virtual account that accommodates all types of financial services in a non-traditional setting.

### Advantages

From the above description a number of advantages of our payment system become evident:
Our system is uniquely customizable with respect to security controls
Our system is uniquely customizable with respect to transaction controls
Our system is unique in its recognition of the relationship between group affiliation and relative transaction risk based on group profiles
Our system is unique in that it permits acceptance of debits in a mobile phone based environment
Our system provides all the capabilities of online banking in a mobile phone based environment
Our system provides all the capabilities of a traditional credit/debit card solution in a mobile phone based environment
Our system permits financial institutions to offers traditional services to non-customers outside their traditional markets
Our system provides the efficiencies of mobile based transactions to our users without the need to implement their own technology
Our system operated independent of any need for hardware purchases or upgrades
Our system operates in real time
Our system maintains details of all transactions and provides users with a full range of report capabilities
Our system is user customizable
Our system can be used independently or in combination with existing financial platforms
Our system can be used to provide financial services to “non-bankable” customers like undocumented individuals or travelers
Our system can accommodate multiple currencies
Our system can accommodated loyalty and rewards program points
Our system is applicable in remote areas and underdeveloped societies

### CONCLUSION, RAMIFICATIONS, AND SCOPE

As one can see, our new payment system provides a multifaceted and comprehensive solution to the challenge of transacting in the mobile phone and Internet based environment.
We make the field of mobile payments accessible to a wide range of users
We offer services without any need for hardware integration
We offer a full range of security and transaction controls
We provide solutions that have application in the widest range of transaction environments
We build upon a recognition of the value of communities in financial transaction analysis

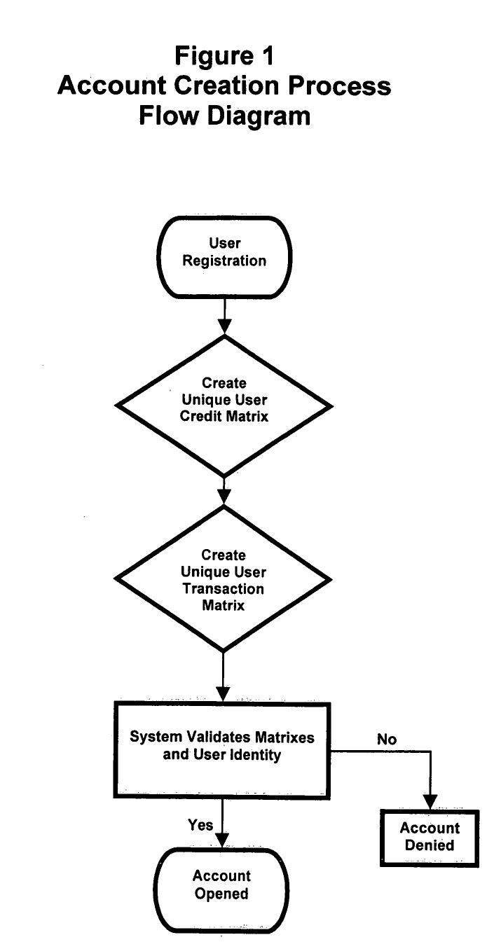

### FIG. 1 Flow Diagram

### Account Creation Process

### Description

User enters the website and registers by providing standard information including information related to user's mobile phone

User is presented with option to create multiple groups into which potential transaction counterparties or “peers” can be included
Peers groups and sub-groups can be established and categorized by degree of relationship desired by user—examples:
   Students at the same college
      Members of a common fraternity, sorority, or club
      Personal friends
      Friends of friends
   Military personnel based at the same facility
      Members of the same unit
      Officers vs. non-officers
   Employees of the same company
      Members of specific departments
   Vendors in a particular shopping area
      User is then presented with ability to create a unique credit matrix to provide the ability to give credit to, or receive credit from, peer groups. User also has the ability to create individual credit profiles.
Credit criteria may include
   Group affiliation
   Personal relationship
   Statistical risk models
   Third party guarantees
   Total system wide credit outstanding
Credit limits may include
   Maximum dollar amount
   Number of transactions per time period
   Interest rate schedules
   Specific purpose
      User is then presented with ability to create a unique transaction matrix to limit or impose restrictions on the types of transactions that can be completed using the system. These controls will serve to reduce the risk of fraud in the system or to increase the efficiency of the system.
Security transaction criteria may include
   Requirement for use of PIN (personal identification number) to confirm transactions in a mobile environment
      May be applied for transactions above a certain amount
      May be applied for transaction with certain peer groups while eliminated for other peer groups
   Maximum transaction amounts using the system
      Per transaction, per day
      Per peer
Transaction controls may be imposed to add efficiency to system
   Quicker processing of transactions
      Waive requirement for certain real-time features like PIN application or SMS transaction verification
      a Internet based vs. mobile phone based alternatives
   Cost efficiencies
      E-mail confirmations vs. SMS confirmations
      a Waiver of confirmations among certain peer groups

Once the registration and the matrixes are submitted the system will validate the identity of the user and the mobile phone, e-mail, bank, and other information provided. It will also analyze the matrixes for errors or conflicts.

Assuming all information is correct the account will be approved and opened for use.

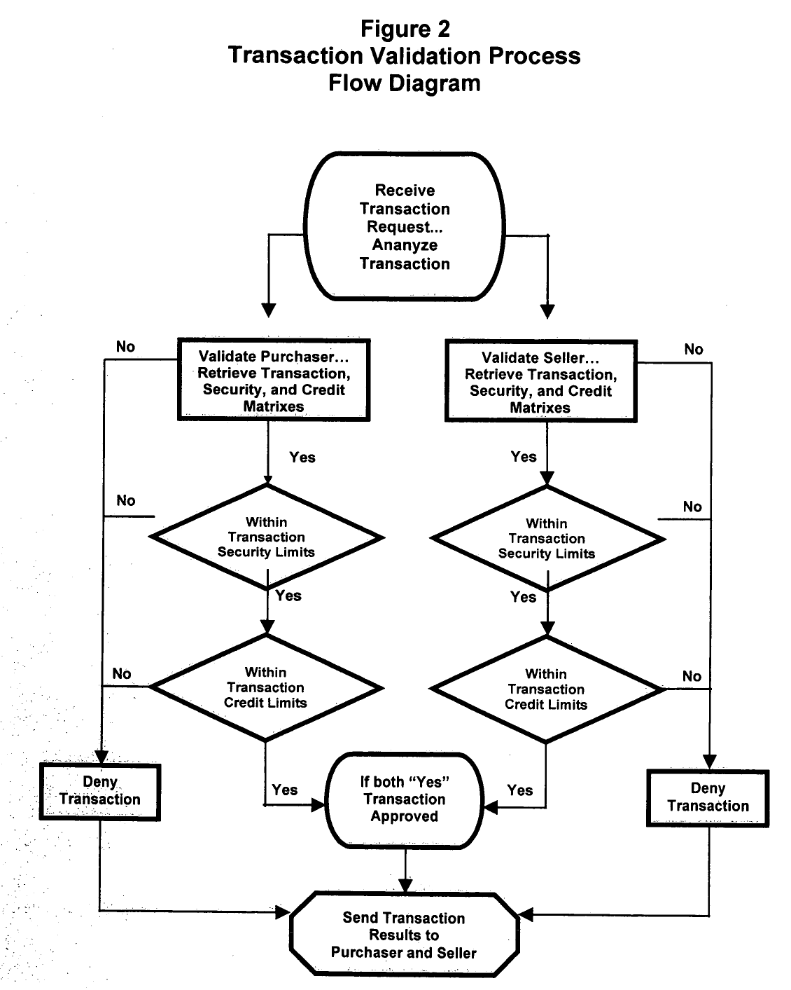

### FIG. 2 Flow Diagram

### Transaction Validation Process

### Description

Financial transaction is initiated by either peer: Payor/Purchaser or by Payee/Seller
Using mobile phone—SMS Text Message, application, web browser
Online
   CelPog processing function
Validates identity of both parties
Analyzes the incoming message to determine its intended purpose
Retrieves the individual transaction, security, and credit criteria established by each party

Transaction is analyzed for compliance with transaction security limits imposed by both parties
If no additional information is required the transaction will proceed
If additional steps are required then the system will send out message asking for additional compliance

Transaction is analyzed for compliance with applicable credit criteria
If balance is sufficient then transaction is approved and both Payor and Payee accounts are adjusted
   Confirmation SMS messages are sent to both parties
If balance is not sufficient—or if transaction is specifically identified as a credit transaction—then:
   System identifies the Risk Matrix applicable to the transaction
   System determines if the transaction meets the requirements of the Risk Matrix to warrant approval
      If no, then the transaction is denied
         Denial SMS messages are sent to both parties
      If yes, then transaction is approved and both Payor and Payee accounts are adjusted
         Approval SMS messages are sent to both parties

1. A method of providing mobile phone based and Internet or Web-based financial transactions complete with integrated user defined credit and security matrixes, said method comprising:
Maintaining customer accounts which can be created via mobile phone text messages or mobile phone applications, or mobile phone Internet or Web-based access protocols, or;
Maintaining customer accounts which can be created via Internet or Web-based protocols or via physical account applications;
Allowing customers to assign and link multiple user defined account identifiers including multiple email addresses, mobile phone numbers, personalized nicknames, and real names;
Allowing customers to identify and link personal profile characteristics including, but not limited to, social, professional, financial, employment, geographic, interest, hobby, educational, age, and other personal information;
Allowing customers to identify and link independent banking relationships, credit card relationships, debit card relationships, and other financial associations and relationships whether actual, anticipated, or desired;
Allowing customers to create and link passwords and personal identification numbers (hereinafter referred to as “PIN”) to be used for account access and identity verification purposes;
Allowing customers to create, identify, categorize, group, validate, and quantify relationships with other customers and administer these relationships via mobile phone networks, Internet or Web-based protocols, or traditional phone or physical means;
Allowing customers to search out other customers by any of the various customer identifiers included in the various customer profiles;
Allowing customer to extend invitations to other customers that will indicate an existing, desired, anticipated, relationship between the parties;
Allowing customer who receive invitations to accept, reject, or put on hold the creation of the relationship desired;
Allowing the customer to assign unique attributes, qualifications, scores, groupings, and other criteria to each of their relationship counterparties.

2. A method of creating a user defined credit matrix that links to the accounts described in claim 1, said method further comprising:
Allowing a customer to consider each of the profile attributes linked to counterparty customers and to assign a credit risk tolerance factor (hereinafter referred to as a “CRTF”) to each of the profile attributes either individually or by group classification;
Allowing the customer to consider the changing financial characteristics of the counterparty's account as maintained by the account platform including, but not limited to, financial exposure issues linked to the counterparty like total debt, number, frequency, size, and other characteristics of prior transactions, and to assign CRTFs to these;
Allowing the customer to organize these CRTFs into a matrix form using various mobile phone, Internet and Web-based tools and features.

3. A method of combining the methods identified in claim 1 and in claim 2 to provide a platform whereby user defined transaction criteria must be satisfied prior to approval and completion of anticipated financial transactions:
Allowing financial transactions to be scrutinized for multiple factors as defined by the users prior to acceptance by the financial platform.

4. A method of completing mobile phone, Internet, and Web-based financial transactions using the methods described in claims 1, 2, and 3 including:
Allowing payments between customers after having satisfied the various CRTFs criteria defined by the parties;
Allowing extension of credit between the parties in the form of agreed upon credits and debits;

5. A method of creating a user defined security limit matrix that links to the accounts described in claim 1, said method further comprising:
Allowing a customer to consider various security controls that would limit use of the system based on counterparty's profile attributes and to assign a security risk tolerance factor (hereinafter referred to as a “SRTF”) to each of the profile attributes either individually or by group classification;
Allowing the customer to consider various security controls which would limit use of the system based on controlling the user's account access to account features including limits on the amount, frequency, and access mode (mobile phone, Internet, applications, etc.);
Allowing the customer to organize these SRTFs into a matrix form using various mobile phone, Internet and Web-based tools and features.
